(19) United States
(12) Patent Application Publication
(10) Pub. No.: US 2019/0141067 A1
(43) Pub. Date: May 9, 2019

(54) DEEP RECURRENT NEURAL NETWORK FOR CLOUD SERVER PROFILING AND ANOMALY DETECTION THROUGH DNS QUERIES

(71) Applicant: Cisco Technology, Inc., San Jose, CA (US)

(72) Inventors: David Brandon Rodriguez, Berkeley, CA (US); Thibault Gilbert Reuille, San Francisco, CA (US); Thomas M. Mathew, Sunnyvale, CA (US)

(21) Appl. No.: 15/808,052

(22) Filed: Nov. 9, 2017

(51) Int. Cl. H04L 29/06; G06N 3/04; G06N 3/08

(52) U.S. Cl. CPC H04L 63/1425; G06N 3/08; G06N 3/0445

(57) ABSTRACT

A method includes arranging a plurality of network domains from DNS server logs into a cohort of network domains, wherein the DNS server logs are for at least one client internet protocol (IP) source address, extracting, from the cohort of network domains, a plurality of features related to the network domains in the cohort of network domains, training a recurrent neural network (RNN) based on values of the plurality of features related to the network domains, operating the RNN to make a prediction of expected values for the plurality of features for a future period of time, comparing the expected values to actual values of the plurality of features for the future period of time, and when the expected values differ from the actual values by a predetermined threshold, indicating that a host associated with the at least one client IP source address is operating with an anomaly.

### TECHNICAL FIELD

The present disclosure relates to anomaly detection by monitoring domain name service (DNS) queries.

### BACKGROUND

A domain name service (DNS) server is employed to, among other things, resolve a fully quantified domain name (FQDN) to an Internet Protocol (IP) address. For example, a browser application running on a host computer might receive input from a user when the user selects a link on a webpage. The link is associated with content that is desired to be accessed by the user, but the content might be stored on a remote server. In order for the browser to obtain the content from the remote server, the browser must first obtain an IP address of the remote server. In this regard, a DNS server is configured to resolve a given FQDN provided in a DNS request, which is sent by the browser, to a corresponding IP address. The corresponding IP address is returned to the browser by the DNS server in a DNS response.

DNS servers do not just process end client browser requests. In the context of cloud computing, where, e.g., multiple interconnected application servers are operating, a given application server might send a DNS request to obtain an IP address of another application server (or virtual machine running on a given server) within the cloud. A given application server might also send a DNS request to obtain an IP address outside of the cloud. Thus, DNS requests from both outside and inside a cloud environment are processed by DNS servers.

### BRIEF DESCRIPTION OF THE DRAWINGS

FIG. 1 depicts an electronic communications network in which anomaly detection logic may operate in accordance with an example embodiment.

FIG. 2 depicts a process to profile a cohort of IP addresses and train a recurrent neural network in accordance with an example embodiment.

FIG. 3A is a schematic diagram of a recurrent neural network with k hidden layers in accordance with an example embodiment.

FIG. 3B is a schematic diagram of an example implementation of a recurrent neural network in accordance with an example embodiment.

FIG. 4 is a schematic diagram of a queue anomaly detection process in accordance with an example embodiment.

FIG. 5 is a flow chart of a series steps for performing anomalous behavior detection based on DNS queries in accordance with an example embodiment.

FIG. 6 is a block diagram of a device (e.g., a server) on which anomaly detection logic may be implemented.

### DESCRIPTION OF EXAMPLE EMBODIMENTS

### Overview

A methodology is provided for detecting anomalous behavior via DNS request analysis. A method includes arranging a plurality of network domains from DNS server logs into a cohort of network domains, wherein the DNS server logs are for at least one client internet protocol (IP) source address, extracting, from the cohort of network domains, a plurality of features related to the network domains in the cohort of network domains, training a recurrent neural network (RNN) based on values of the plurality of features related to the network domains, operating the RNN to make a prediction of expected values for the plurality of features for a future period of time, comparing the expected values to actual values of the plurality of features for the future period of time, and when the expected values differ from the actual values by a predetermined threshold, indicating that a host associated with the at least one client IP source address is operating with an anomaly.

In another embodiment, a device is provided. The device includes an interface unit configured to enable network communications, a memory, and one or more processors coupled to the interface unit and the memory, and configured to: arrange a plurality of network domains from domain name service server logs into a cohort of network domains, wherein the domain name service server logs are for at least one client internet protocol (IP) source address, extract, from the cohort of network domains, a plurality of features related to the network domains in the cohort of network domains, train a recurrent neural network based on values of the plurality of features related to the network domains, operate the recurrent neural network to make a prediction of expected values for the plurality of features for a future period of time, compare the expected values to actual values of the plurality of features for the future period of time, and when the expected values differ from the actual values by a predetermined threshold, indicate that a host associated with the at least one client IP source address is operating with an anomaly.

### Example Embodiments

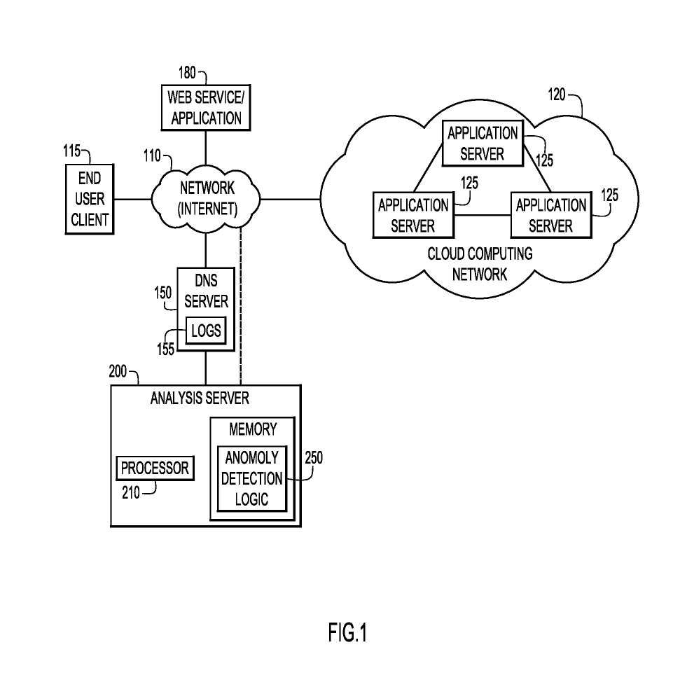

FIG. 1 depicts an electronic communications network in which anomaly detection logic may operate in accordance with an example embodiment. Specifically, a network 110, such as the Internet, interconnects an end user client 115, a cloud computing network 120 having a plurality of applications servers 125 that are in communication with one another, a DNS server 150 and a web service or application 180 outside of cloud computing network 120. Those skilled in the art will appreciate that FIG. 1 is a simplified diagram showing only one or a few of each network element. In a real world implementation, multiple DNS servers 150 might operate in a distributed manner, and there may be hundreds or thousands instances of each of end user client 115, application servers 125 and web service or applications 180.

As noted, DNS server 150 is employed to, among other things, resolve a fully quantified domain name (FQDN) to an Internet Protocol (IP) address. For example, a browser application running on end user client 115 (e.g., a computer) might receive input from a user when the user selects a link on a webpage. The link is associated with content or service that is desired to be accessed by the user, but the content or service might be stored on a remote server. In order for the browser to obtain the content or service from the remote server (e.g., web server or application 180), the browser must first obtain an IP address of the remote server. In this regard, DNS server 150 is configured to resolve a given FQDN provided in a DNS request, which is sent by the browser, to a corresponding IP address. The corresponding IP address is returned to the browser (i.e., end user client 115) by DNS server 150 in a DNS response.

DNS server 150, however, does not just process end user client browser requests. In the context of cloud computing network 120, where, e.g., multiple application servers 125 are running and are in communication with each other, a given application server 125 might send a DNS request to obtain an IP address of (or other information from) another application server 125 within the cloud. A given application server might also send a DNS request to resolve an IP address that is outside of the cloud, e.g., for web service or application 180.

Thus, DNS requests from both outside and inside cloud computing network 120 are processed by DNS server 150.

DNS requests can provide insight into how a given end user client 115 or application server 125 is behaving. For simplicity, the following discussion will be with respect to monitoring the behavior of application servers 125. However the techniques described herein are applicable to any network element that sends a DNS request, including end user client 115. In current implementations, DNS server 150 might “see” 5,000-10,000 different client IP source addresses hourly, where a “client IP source address” is the IP address of an application server 125 from which a DNS request originates. These client IPs may be acting as mail servers, webservers, data warehouses, etc. Depending on the function, these servers may be prone to various risks of infection, intrusion and spreading malware. Thus, the more quickly such an infection, intrusion or malware is detected, the more quickly appropriate counter measures can be deployed.

In accordance with an embodiment, DNS server 150 captures logs 155 of DNS requests sent by application servers 125. Logs 155 may cover hours, days, weeks, or months of collected DNS request data from application servers 125, identified via respective IP source addresses. Logs 155 indicate which other application servers 125 and web service or applications 180 given application servers 125 attempt to reach, how often DNS requests are made, and metadata regarding the DNS requests, such as whether a given DNS request was dropped, denied, placed in quarantine, or replied to, among other possibilities.

In accordance with example embodiments, logs 155 may be analyzed to detect anomalous behavior compared to historical “norms.” Specifically, analysis server 200 shown in FIG. 1 includes a processor 210 and memory 220. The memory 220 may store logic instructions for anomaly detection logic 250. As will be described in more detail below, anomaly detection logic 250 may include logic to implement a recurrent neural network (RNN) that analyzes groups of client IP addresses and domains they sought to reach, as “cohorts”, and that makes predictions about expected behavior of clients to detect anomalous real time behavior by one or more application servers 125.

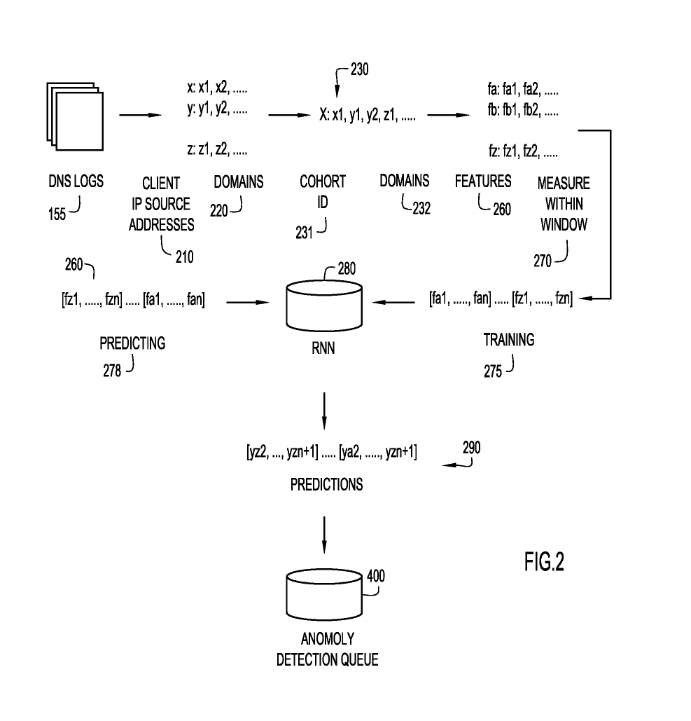

FIG. 2 depicts a process to profile a cohort of IP addresses and train a recurrent neural network in accordance with an example embodiment. This process may be performed by anomaly detection logic 250. As shown, the process may include several operations. From DNS logs 155, client IP source addresses 210, and domains 220 they attempted to reach, are arranged into one or more cohorts 230 with a respective cohort ID 231. Each cohort 230 includes all of the domains 232 that were attempted to be reached by all of the client IP source addresses selected for the given cohort 230. In this regard, a cohort 230 might include all the client IPs related to one organization or merely include a single client IP. The choice of cohort size determines the level at which anomalies may be flagged, and thus the size may vary for different reasons.

The collection of domains 232 for a given cohort 230 is then analyzed to extract sets of “features” 260, examples of which are provided below. In accordance with an embodiment, a time window 270 (e.g., hourly) can be applied to feature extraction. For example, from DNS logs 155, the domains 220 sought by client IP source addresses 210 can be collected for, e.g., a period between 2:00 pm-3:00 pm, any other hour or all hours. The features 260 that would be identified would then be analyzed for that time window 270. In FIG. 2, feature “fa,” for example, is organized by time window 1 (fa1), time window 2 (fa2), etc.

In one implementation, the DNS traffic of the cohort of client IPs is analyzed as if all the traffic originated from one source. For example, a server A might have made x1, x2, . . . DNS queries while server B might have made y1, y2, . . . individually, but as a cohort their traffic is now mixed such that, at the cohort level, their traffic might appear as: x1, y1, y2, x2, . . . , for example, as indicated by 230. From this sequence, a variety of features are derived.

Features include:

# of alexa 1 million domains

# of alexa 1 million queries

# of application programming interface (api) domains

# of api queries

# of blacklist lookup domains

# of blacklist lookup queries

# of blocked domains

# of blocked queries

# of queries to original tlds (top level domains)

# of queries to country code tlds

# of queries to infrastructure tlds

# of queries to other tlds (gtlds, etc.) (generic tlds)

# of MX (mail server) queries

# of A (IPv4) queries

# of AAAA (IPv6) queries

# of TXT (text) queries

# of NX (nonexistent, non-resolved) queries

By comparing one time window to one or more time windows in the past, the following features can be generated:

Jaccard similarity of the domains

# new domains

# new queries

The extracted feature sets or training “signals” 275 are then used to train a recurrent neural network (RNN) 280 (taking an input sequence and producing an output sequence). RNN 280 is configured to make predictions 290 for hourly periods (or any other time increment) for each of the signals.

Then, at 278, another features set 260, obtained for a subsequent similarly-sized time window is fed into the RNN 280. RNN 280 then generates still more predictions 290. These latter predictions are then compared to an expected prediction based on the training of the RNN 280.

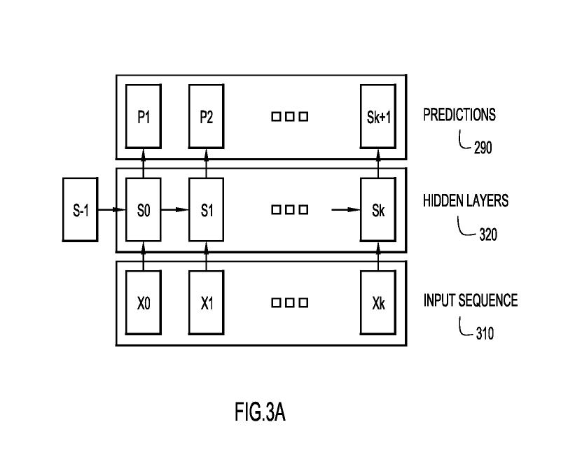

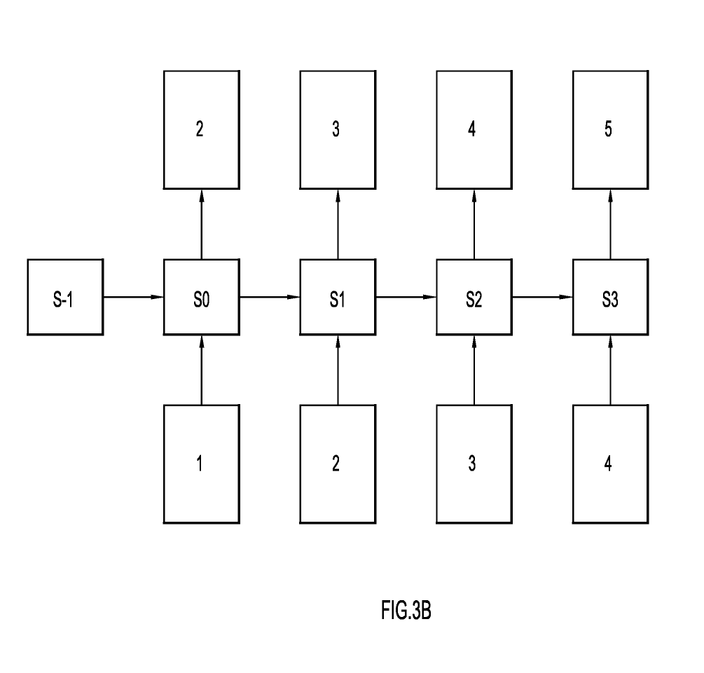

FIG. 3A is a schematic diagram of a suitable RNN 280 with k hidden layers in accordance with an example embodiment. As shown in FIG. 3A, an input sequence 310 is supplied to hidden layers 320, which provide predictions 290.

More specifically, RNN 280 may be configured as follows: let x=[x1, . . . , xn] be a signal, containing one computed feature, with xi a measure constructed from an hour window of DNS traffic we then predict a=[a2, . . . , an, an+1] where a2=x2, an=xn and an+1 is the expected next value in the sequence. FIG. 3B is a schematic diagram of an example implementation of a recurrent neural network in accordance with an example embodiment. That is, the RNN 281 of FIG. 3B is an example of a “many to many” RNN architecture taking a sequence of values: 1, 2, 3, 4 and predicting the translation of the input: e.g. 2, 3, 4, 5.

The hidden number of cells is chosen to be large enough to capture the (e.g., sinusoidal) pattern of day/night traffic of 24 hours and the week/weekend sinusoidal patterns as well. Therefore a hidden number of nodes is chosen as 7*24+j, where j is chosen based on the truncated backpropagation algorithm used.

RNN 280 is trained on all the signals: x,y, . . . , by windowing each signal, then training the RNN to predict the next window (sliding by 1) for each signal. Note that it is possible to retrain a model by using the previous model's stored weights to hot start a new model and incorporate the new information by training as before. In this sense, the model is configured to learn.

With a trained RNN 280, it is possible to take a window of a signal and predict the value for the next time step. In other words, and referring again to FIG. 2, predictions 290 are then supplied to an anomaly detection queue 400 that is configured to compute differences between observed and predicted values from RNN 280 for each signal and aggregate those differences.

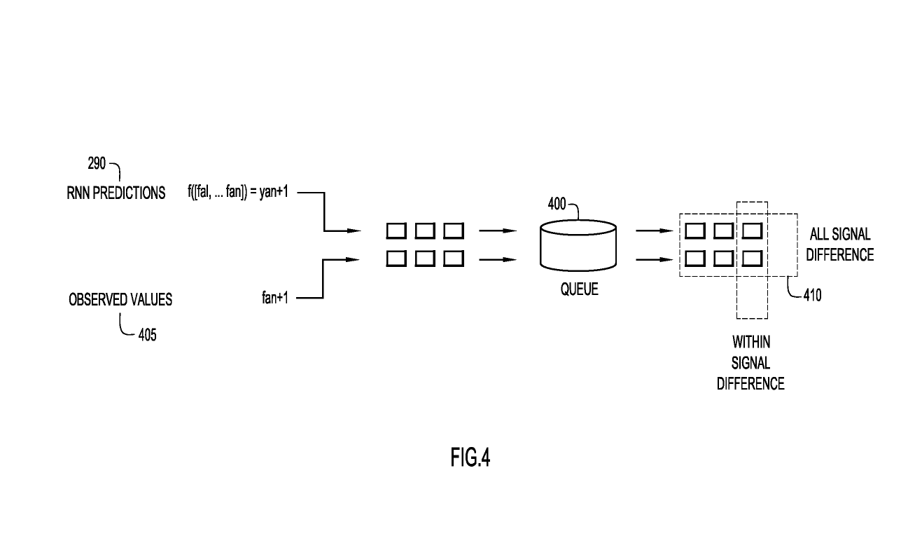

Anomaly detection logic 250 is configured to then flag anomalies by maintaining a queue like data structure 400 holding the most recent (perhaps 7 days for example) of predicted and observed (or actual) values 405 from the signals. FIG. 4 is a schematic diagram of a queue anomaly detection process 410 for one signal, in accordance with an example embodiment.

For some user defined threshold, anomaly detection logic 250 is configured to flag anomalies within one signal by the following observation. From a sequence x=[x1, x2, x3, . . . ] an output sequence a=[a2, a3, a4, . . . ] is produced. Shifting x, Tx=[x2, x3, . . . ], the predicted value is compared to the observed value as xi−ai. In fact, this comparison analysis can be generalized as: ∥Tx−a∥_i to any norm i. The norm captures the magnitude of difference between expected and observed signal values where a user defined threshold is applied. If the norm exceeds a threshold an alert is made. Stated alternatively, the expected values are compared to the actual values by feeding the expected and the actual values into an anomaly detection queue that computes residual differences per signal, per time interval. The residual differences are concatenated into a matrix storing the historical prediction errors per signal, and the matrix norm is then computed. If the norm exceeds a user defined threshold, an alert is made.

Further, anomaly detection logic 250 is configured to flag anomalies amongst all the signals being enqueued, by the following observation. From a set of signals: x,y, . . . and predicted values a,b, . . . we can compute the norm of all the observed and predicted values xi−ai, yi−bi, etc. Therefore, if we let X=[xi, yi, . . . ] and A=[ai, bi, . . . ], then we can take the matrix norm: ∥X−A∥_i for any integer i. For example, taking the Frobenius norm the magnitude of difference between expected and observed values for all the signals is measured where a user defined threshold is applied. If the norm exceeds a threshold an alert is made.

In addition, anomaly detection logic 250 can maintain a record of the difference between the predicted and observed values from one signal or all the signal for a specified period of time, for example, 7 days. If any of the values is above a predetermined threshold or the sum total of values is above a predetermined threshold, anomaly detection logic 250 can flag such an event as anomalous.

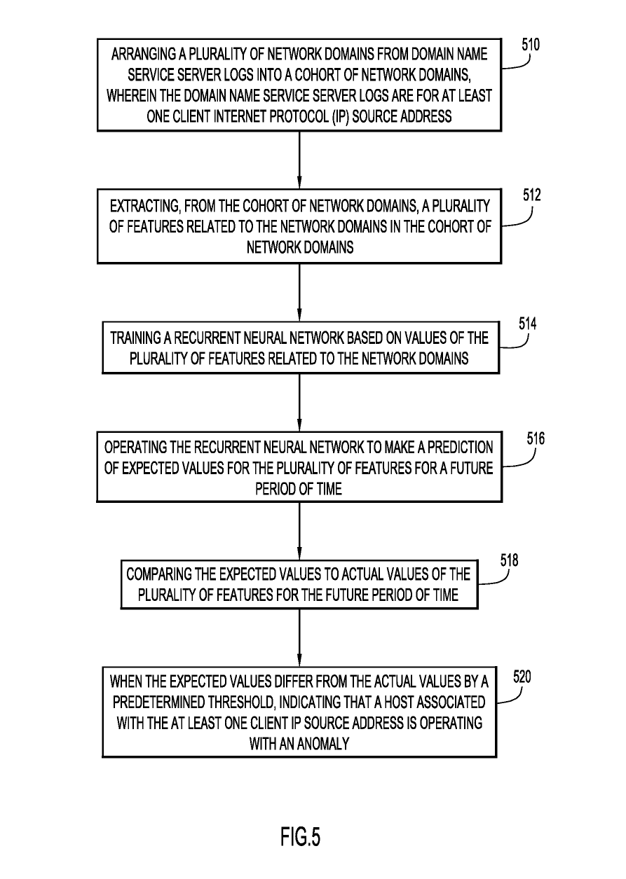

FIG. 5 is a flow chart of a series steps for performing anomalous behavior detection based on DNS queries in accordance with an example embodiment. In accordance with an embodiment, a process includes, at 510, arranging a plurality of network domains from domain name service server logs into a cohort of network domains, wherein the domain name service server logs are for at least one client internet protocol (IP) source address. At 512, the process continues by extracting, from the cohort of network domains, a plurality of features related to the network domains in the cohort of network domains. At 514, the process continues by training a recurrent neural network based on values of the plurality of features related to the network domains. At 516, the process includes operating the recurrent neural network to make a prediction of expected values for the plurality of features for a future period of time. At 518 the process compares the expected values to actual values of the plurality of features for the future period of time. And, at 520, when the expected values differ from the actual values by a predetermined threshold, the process indicates that a host associated with the at least one client IP source address is operating with an anomaly.

Thus, the instant embodiments provide a methodology to provide cloud security by extracting novel features that distinguish the type of server (mail, web, data warehouse, etc.) and learn their typical usage patterns to provide anomaly detection. The instant embodiment are enable by the unique application of a recurrent neural network, which can learn operational patterns based on inputs from DNS logs. Anomalies are detected not only as a result of detected “spiking” behavior, but also by using a queue like data structure and methods to compute the residual difference between the observed and expected values we can identify “drift” when the observed and expected values vary by small magnitudes but for long periods of time.

The instant embodiments are advantageous in view of the unique features for server profiling derived from DNS traffic and the deployment of a deep learning model which can learn usage pattern and detect anomalies. The model can also be retrained without resetting or losing previously trained representations.

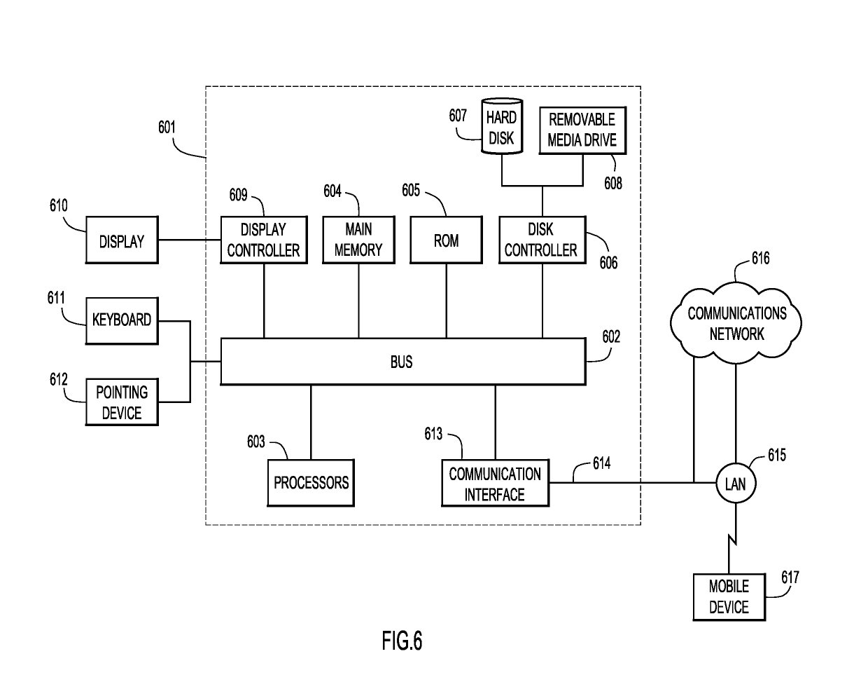

FIG. 6 is a block diagram of a device or apparatus (e.g., a server) on which anomaly detection logic may be implemented. The apparatus may be implemented on or as a computer system 601. The computer system 601 may be programmed to implement a computer based device. The computer system 601 includes a bus 602 or other communication mechanism for communicating information, and a processor 603 coupled with the bus 602 for processing the information. While the figure shows a single block 603 for a processor, it should be understood that the processor 603 represents a plurality of processors or processing cores, each of which can perform separate processing. The computer system 601 may also include a main memory 604, such as a random access memory (RAM) or other dynamic storage device (e.g., dynamic RAM (DRAM), static RAM (SRAM), and synchronous DRAM (SD RAM)), coupled to the bus 602 for storing information and instructions (e.g., the logic 250) to be executed by processor 603. In addition, the main memory 604 may be used for storing temporary variables or other intermediate information during the execution of instructions by the processor 603.

The computer system 601 may further include a read only memory (ROM) 605 or other static storage device (e.g., programmable ROM (PROM), erasable PROM (EPROM), and electrically erasable PROM (EEPROM)) coupled to the bus 602 for storing static information and instructions for the processor 603.

The computer system 601 may also include a disk controller 606 coupled to the bus 602 to control one or more storage devices for storing information and instructions, such as a magnetic hard disk 607, and a removable media drive 608 (e.g., floppy disk drive, read-only compact disc drive, read/write compact disc drive, compact disc jukebox, tape drive, and removable magneto- optical drive). The storage devices may be added to the computer system 601 using an appropriate device interface (e.g., small computer system interface (SCSI), integrated device electronics (IDE), enhanced-IDE (E-IDE), direct memory access (DMA), or ultra-DMA).

The computer system 601 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices. .

The computer system 601 may also include a display controller 609 coupled to the bus 602 to control a display 610, such as a cathode ray tube (CRT) or liquid crystal display (LCD), light emitting diode (LED) display, for displaying information to a computer user. The computer system 601 may include input devices, such as a keyboard 611 and a pointing device 612, for interacting with a computer user and providing information to the processor 603. The pointing device 612, for example, may be a mouse, a trackball, or a pointing stick for communicating direction information and command selections to the processor 603 and for controlling cursor movement on the display 610. In addition, a printer may provide printed listings of data stored and/or generated by the computer system 601.

The computer system 601 performs a portion or all of the processing operations of the embodiments described herein in response to the processor 603 executing one or more sequences of one or more instructions contained in a memory, such as the main memory 604. Such instructions may be read into the main memory 604 from another computer readable medium, such as a hard disk 607 or a removable media drive 608. One or more processors in a multi-processing arrangement may also be employed to execute the sequences of instructions contained in main memory 604. In alternative embodiments, hard-wired circuitry may be used in place of or in combination with software instructions. Thus, embodiments are not limited to any specific combination of hardware circuitry and software.

As stated above, the computer system 601 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 601, for driving a device or devices for implementing the described embodiments, and for enabling the computer system 601 to interact with a human user. Such software may include, but is not limited to, device drivers, operating systems, development tools, and applications software. Such computer readable storage media further includes a computer program product for performing all or a portion (if processing is distributed) of the processing presented herein.

The computer code may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 601 also includes a communication interface 613 coupled to the bus 602. The communication interface 613 provides a two-way data communication coupling to a network link 614 that is connected to, for example, a local area network (LAN) 615, or to another communications network 616. For example, the communication interface 613 may be a wired or wireless network interface card or modem (e.g., with SIM card) configured to attach to any packet switched (wired or wireless) LAN or WWAN. As another example, the communication interface 613 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 613 sends and receives electrical, electromagnetic or optical signals that carry digital data streams representing various types of information.

The network link 614 typically provides data communication through one or more networks to other data devices. For example, the network link 614 may provide a connection to another computer through a local area network 615 (e.g., a LAN) or through equipment operated by a service provider, which provides communication services through a communications network 616. The local network 614 and the communications network 616 use, for example, electrical, electromagnetic, or optical signals that carry digital data streams, and the associated physical layer (e.g., CAT 5 cable, coaxial cable, optical fiber, etc.). The signals through the various networks and the signals on the network link 614 and through the communication interface 613, which carry the digital data to and from the computer system 601 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 601 can transmit and receive data, including program code, through the network(s) 615 and 616, the network link 614 and the communication interface 613. Moreover, the network link 614 may provide a connection to a mobile device 617 such as a personal digital assistant (PDA) laptop computer, cellular telephone, or modem and SIM card integrated with a given device.

In sum, there is provided a methodology including operations of arranging a plurality of network domains from domain name service server logs into a cohort of network domains, wherein the domain name service server logs are for at least one client internet protocol (IP) source address, extracting, from the cohort of network domains, a plurality of features related to the network domains in the cohort of network domains, training a recurrent neural network based on values of the plurality of features related to the network domains, operating the recurrent neural network to make a prediction of expected values for the plurality of features for a future period of time, comparing the expected values to actual values of the plurality of features for the future period of time, and when the expected values differ from the actual values by a predetermined threshold, indicating that a host associated with the at least one client IP source address is operating with an anomaly.

The cohort of network domains may include a single client IP source address, or a plurality of client IP source addresses.

The method may further include training the recurrent neural network using values of the plurality of features over a time period equivalent to the future period of time.

In an embodiment, comparing the expected values to the actual values includes feeding the expected and the actual values into an anomaly detection queue that computes residual differences per signal, per time interval.

Features may include at least one of a number of alexa 1 million domains and a number of alexa 1 million queries, and/or at least one of a number of application programming interface (API) domains and a number of API queries, and/or at least one of a number of blacklist lookup domains and a number of blacklist lookup queries, and/or at least one of a number of blocked domains and a number of blocked queries, and/or at least one of a number of queries to original top level domains (TLDs).

In one implementation, comparing the expected values to actual values of the plurality of features for the future period of time may include computing at least one of a Jaccard similarity of the domains, a number of new domains and a number of new queries.

There is further provided a device that includes a communication interface configured to enable network communications; a memory; and one or more processors coupled to the communication interface and the memory, and configured to: arrange a plurality of network domains from domain name service server logs into a cohort of network domains, wherein the domain name service server logs are for at least one client internet protocol (IP) source address, extract, from the cohort of network domains, a plurality of features related to the network domains in the cohort of network domains, train a recurrent neural network based on values of the plurality of features related to the network domains, operate the recurrent neural network to make a prediction of expected values for the plurality of features for a future period of time, compare the expected values to actual values of the plurality of features for the future period of time, and when the expected values differ from the actual values by a predetermined threshold, indicate that a host associated with the at least one client IP source address is operating with an anomaly.

The cohort of network domains comprises a single client IP source address or a plurality of client IP source addresses.

The one or more processors may be further configured to: train the recurrent neural network by using values of the plurality of features over a time period equivalent to the future period of time.

The one or more processors are further configured to: compare the expected values to the actual values by feeding the expected and the actual values into an anomaly detection queue that computes residual differences per signal, per time interval.

The features comprise at least one of a number of alexa 1 million domains and a number of alexa 1 million queries and/or at least one a number of application programming interface (API) domains and a number of API queries.

The aforementioned methodology may also be embodied in processor executable instructions encoded in one or more processor readable non-transitory tangible media.

The above description is intended by way of example only. Various modifications and structural changes may be made therein without departing from the scope of the concepts described herein and within the scope and range of equivalents of the claims.

What is claimed is:

1. A method comprising:
arranging a plurality of network domains from domain name service server logs into a cohort of network domains, wherein the domain name service server logs are for at least one client internet protocol (IP) source address;
extracting, from the cohort of network domains, a plurality of features related to the network domains in the cohort of network domains;
training a recurrent neural network based on values of the plurality of features related to the network domains;
operating the recurrent neural network to make a prediction of expected values for the plurality of features for a future period of time;
comparing the expected values to actual values of the plurality of features for the future period of time; and
when the expected values differ from the actual values by a predetermined threshold, indicating that a host associated with the at least one client IP source address is operating with an anomaly.

2. The method of claim 1, wherein the cohort of network domains comprises a single client IP source address.

3. The method of claim 1, wherein the cohort of network domains comprises a plurality of client IP source addresses.

4. The method of claim 1, further comprising training the recurrent neural network using values of the plurality of features over a time period equivalent to the future period of time.

5. The method of claim 1, wherein comparing the expected values to the actual values comprises feeding the expected and the actual values into an anomaly detection queue that computes residual differences per signal, per time interval.

6. The method of claim 1, wherein the features comprise at least one of a number of alexa 1 million domains and a number of alexa 1 million queries.

7. The method of claim 1, wherein the features comprise at least one a number of application programming interface (API) domains and a number of API queries.

8. The method of claim 1, wherein the features comprise at least one of a number of blacklist lookup domains and a number of blacklist lookup queries.

9. The method of claim 1, wherein the features comprises at least one of a number of blocked domains and a number of blocked queries.

10. The method of claim 1, wherein the features comprise at least one of a number of queries to original top level domains (TLDs).

11. The method of claim 1, wherein comparing the expected values to actual values of the plurality of features for the future period of time comprises computing at least one of a Jaccard similarity of the domains, a number of new domains and a number of new queries.

12. A device comprising:
a communication interface configured to enable network communications;
a memory; and
one or more processors coupled to the communication interface and the memory, and configured to:
arrange a plurality of network domains from domain name service server logs into a cohort of network domains, wherein the domain name service server logs are for at least one client internet protocol (IP) source address;
extract, from the cohort of network domains, a plurality of features related to the network domains in the cohort of network domains;
train a recurrent neural network based on values of the plurality of features related to the network domains;
operate the recurrent neural network to make a prediction of expected values for the plurality of features for a future period of time;
compare the expected values to actual values of the plurality of features for the future period of time; and
when the expected values differ from the actual values by a predetermined threshold, indicate that a host associated with the at least one client IP source address is operating with an anomaly.

13. The device of claim 12, wherein the cohort of network domains comprises a single client IP source address.

14. The device of claim 12, wherein the cohort of network domains comprises a plurality of client IP source addresses.

15. The device of claim 12, wherein the one or more processors are further configured to:
train the recurrent neural network by using values of the plurality of features over a time period equivalent to the future period of time.

16. The device of claim 12, wherein the one or more processors are further configured to: compare the expected values to the actual values by feeding the expected and the actual values into an anomaly detection queue that computes residual differences per signal, per time interval.

17. The device of claim 12, wherein the features comprise at least one of a number of alexa 1 million domains and a number of alexa 1 million queries.

18. The device of claim 12, wherein the features comprise at least one a number of application programming interface (API) domains and a number of API queries.

19. One or more non-transitory computer readable storage media encoded with software comprising computer executable instructions and when the software is executed operable to:
arrange a plurality of network domains from domain name service server logs into a cohort of network domains, wherein the domain name service server logs are for at least one client internet protocol (IP) source address;
extract, from the cohort of network domains, a plurality of features related to the network domains in the cohort of network domains;
train a recurrent neural network based on values of the plurality of features related to the network domains;
operate the recurrent neural network to make a prediction of expected values for the plurality of features for a future period of time;
compare the expected values to actual values of the plurality of features for the future period of time; and
when the expected values differ from the actual values by a predetermined threshold, indicate that a host associated with the at least one client IP source address is operating with an anomaly.

20. The non-transitory computer readable storage media of claim 19, wherein the cohort of network domains comprises a plurality of client IP source addresses.
